(19) United States
(12) Patent Application Publication
(10) Pub. No.: US 2013/0218930 A1
(43) Pub. Date: Aug. 22, 2013

(54) XML FILE FORMAT OPTIMIZED FOR EFFICIENT ATOMIC ACCESS

(71) Applicants: Matthew Wood, Seattle, WA (US); Jonathan Bailor, Bellevue, WA (US); Robert Little, Redmond, WA (US); Brian Marshall, Kirkland, WA (US); Andrew Smith, Redmond, WA (US)

(72) Inventors: Matthew Wood, Seattle, WA (US); Jonathan Bailor, Bellevue, WA (US); Robert Little, Redmond, WA (US); Brian Marshall, Kirkland, WA (US); Andrew Smith, Redmond, WA (US)

(73) Assignee: Microsoft Corporation, Redmond, WA (US)

(21) Appl. No.: 13/400,344

(22) Filed: Feb. 20, 2012

(51) Int. Cl. G06F 17/30

(52) U.S. Cl. 707/803; 707/E17.019

(57) ABSTRACT

Systems and methods are disclosed that provide a flexible file capable of storing rich content. A flexible file may include a section object, one or more tile objects stored within the section object, and one or more clip objects associated with each tile object. A clip objects may store a content item. Alternatively a clip object may store one or more references to a content item, the content item being stored externally to the flexible file. The disclosed flexible file allows an application to adjust the atomicity based upon the needs of a user or application.

### BACKGROUND

Applications that store a rich collection of content in a single file often face many obstacles to operability. If a large amount of content is stored within the file itself, the time required to load the file may adversely affect the user experience. However, if the file references external content, computational resources may be overburdened by the number of requests and retrieval operations required to access the content. It is with respect to this general environment that embodiments of the present disclosure have been contemplated.

Although specific problems have been addressed in this Background, this disclosure is not intended in any way to be limited to solving those specific problems.

### SUMMARY

Embodiments of the present disclosure relate to a flexible file that may be optimized for efficient atomic access. The embodiments disclosed herein may be used in conjunction with any type of software application (e.g., word processors, presentation software, diagramming software, etc.). Additionally, the embodiments disclosed herein may be utilized with applications that provide users with a large amount of content. The disclosed flexible file provides applications with the ability to collect and/or aggregate a large amount of content while striking a balance between the needs of a user and the burden placed on local and network computing resources. The flexible file disclosed herein provides flexibility by allowing a varying degree of atomicity with respect to how the aggregated content is retrieved and/or stored.

In further embodiments, the flexible file also provides resiliency with respect to the movement of content on a network. As discussed, the flexible file format is capable of storing actual content or references to content. If a file stores references to content, movement of the content may break the references thereby prohibiting the file from later accessing and/or retrieving the file. Embodiments disclosed herein provide resiliency against the movement of content by storing a variety of different references for each content item. In embodiments, each reference may link to the same content item in a different manner, thereby providing the flexible file with multiple mechanisms to find and retrieve content.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The same number represents the same element or same type of element in all drawings.

FIG. 1 is a conceptual illustration of an embodiment of a flexible file 100.

FIG. 2 is an embodiment of flexible file components that may be used to provide high atomicity in an offline mode.

FIG. 3 is an embodiment of flexible file components that may be used to provide high atomicity in an online mode.

FIG. 4 is an embodiment of flexible file components that may be used to provide a balanced level of atomicity in an online mode.

FIG. 5 is an embodiment of a method 500 that may be employed to create a flexible file.

FIG. 6 is an embodiment of a network system 600 that may be employed with the various embodiments described herein.

FIG. 7 illustrates an embodiment of a computer environment and computer system 700 for implementing the methods disclosed herein.

FIG. 8A illustrates one embodiment of a mobile computing device 800 for executing embodiments of creating and utilizing embodiments of flexible file formats described herein.

FIG. 8B is a simplified block diagram of an exemplary mobile computing device system 802 suitable for practicing embodiments of the flexible file format disclosed herein.

FIG. 9 illustrates an embodiment of a system for providing the embodiments disclosed herein to one or more client devices.

### DETAILED DESCRIPTION

This disclosure will now more fully describe exemplary embodiments with reference to the accompanying drawings, in which some of the possible embodiments are shown. Other aspects, however, may be embodied in many different forms and the inclusion of specific embodiments in the disclosure should not be construed as limiting such aspects to the embodiments set forth herein. Rather, the embodiments depicted in the drawings are included to provide a disclosure that is thorough and complete and which fully conveys the intended scope to those skilled in the art. When referring to the figures, like structures and elements shown throughout are indicated with like reference numerals.

Embodiments of the present disclosure relate to a flexible file format that may be optimized for efficient atomic access. The embodiments disclosed herein may be used in conjunction with any type of software application (e.g., word processors, presentation software, diagramming software, etc.). Additionally, the embodiments disclosed herein may be utilized with applications that provide users with a large amount of content. For example, the flexible file format disclosed herein may be utilized by an application that creates montages. A montage may be a rich collection of pictures, documents, presentations, spreadsheets, diagrams, audio files, videos, web content, or any other type of digital content that a user or application aggregates and provides for display and/or consumption. For ease of description, the discussion herein will refer to the creation of montages when describing the flexible file format. However, one of skill in the art will appreciate that the flexible file format disclosed herein may be employed to create any type of file for any type of application, and will not construe the embodiments disclosed herein as being limited to the creation of montages.

Rich collections, such as montages, may consist of a large number of files. Because of this, a standard file storing a montage, or a large amount of content in general, may place a heavy burden on local computing and network computing resources. The size of the collection may also adversely affect the user experience when a user attempts to access or open the file. For example, if all of the content collected in the montage is stored in the montage file, opening the file and displaying content to the user may take an unreasonably long period of time due to the amount of content that is loaded. On the other hand, if the montage file consists of a collection of references to content, rather than the content itself, the size of the file may be much smaller thereby providing a quick initial load for the user; however, every piece of content that the user selects from the file may have to be retrieved. Because the references stored in the file may direct the user to both content stored locally and content stored remotely over a network, accessing the links in the file to retrieve the content may place a heavy burden on local and network resources.

Embodiments of the flexible file format disclosed herein strike a balance between the described situations and provide the application with the ability to collect and/or aggregate a large amount of content while striking a balance between the needs of a user and the burden placed on local and network computing resources. Thus, the flexible file format provides for the creation of a file that balances load times with the amount of retrievals required while allowing a user and/or and applications to aggregate a large amount of content. Furthermore, the flexible file may be tailored to fit particular user performance needs and/or to work with available computing resources.

The embodiments of the flexible file disclosed herein may provide flexibility by providing a varying degree of atomicity with respect to how the aggregated content is retrieved and/or stored. In embodiments, atomicity refers to the manner in which content is stored. A high degree of atomicity may refer to content that is stored individually. For example, a file in which each piece of content is stored or referenced individually has a high degree of atomicity. When a high degree of atomicity is provided, at least some content may be individually accessed or retrieved. Conversely, a low degree of atomicity may refer to content that is stored as a group or collection. For example, a file in which each piece of content is stored together (e.g., in a single container, file, directory, etc.) has a very low degree of atomicity. When a low degree of atomicity is provided, at least some of the content may not be individually accessed or retrieved. Instead, the content may be accessed or retrieved as a group.

A file that provides high atomicity may increase the user experience by providing a quick load time. Because content may be individually accessed in a highly atomic environment, the user only has to wait for the content he or she selected to be retrieved therefore load time is reduced. However, individually accessing a large number of content in a highly atomic environment increases the number of retrievals and requests and may, therefore, increase the burden on local and network resources.

A file that provides low atomicity may decrease the number of requests and retrievals required, thereby reducing the burden on local and network computing resources. However, because content is accessed as a group in a low atomic environment, the user experience may be degraded because a user may have to wait not only for user selected content, but for additional content as well.

In embodiments, the flexible file format is able provide a varying degree of atomicity, thereby striking a balance between the user experience and use of computing resources. For example, the flexible file format may store some content that will be frequently accessed individually, thereby ensuring a positive user experience, while storing other content as a group (e.g., content that is likely to be accessed together), thereby relieving stress on the computing resources.

In embodiments, the flexible file format may also provide a degree of resiliency with respect to the movement of content. As discussed, the flexible file format is capable of storing actual content or references to content. When a reference to content is stored, the file may lose access to the content if it is moved. Embodiments provide resiliency against the movement of content by storing a number of different references for each content item. In embodiments, each reference may link to the content in a different manner, thereby providing the flexible file with multiple mechanisms to find and retrieve content.

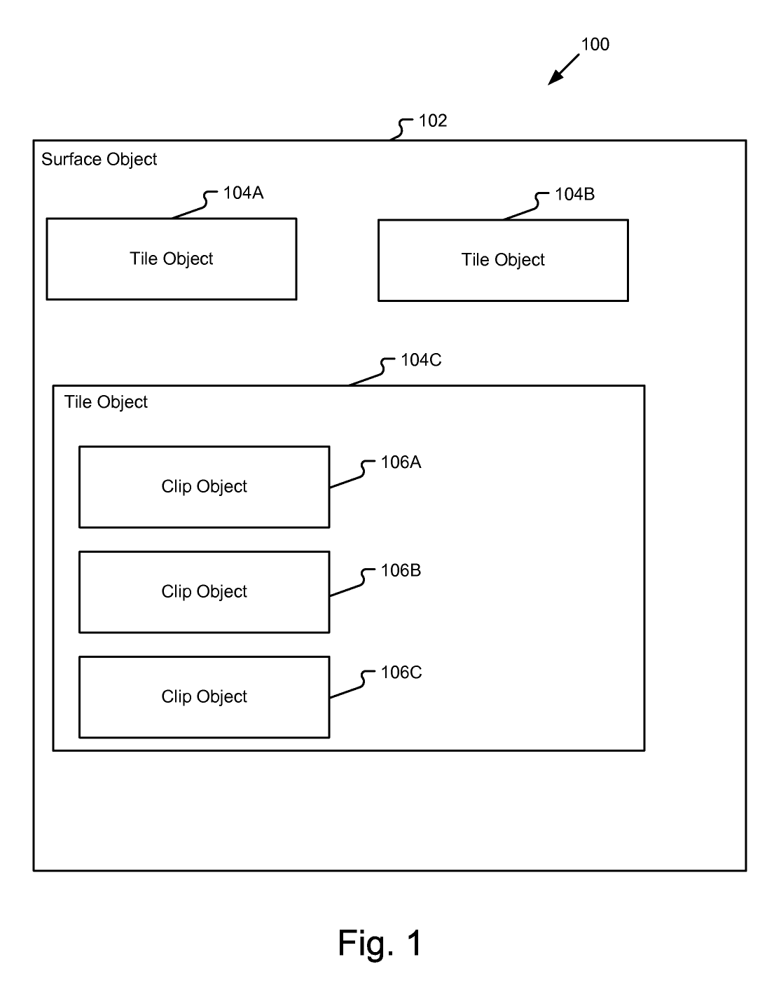

FIG. 1 is a conceptual illustration of an embodiment of a flexible file 100. In the described embodiments, the flexible file may be used by a montage application to store a montage of content. In other embodiments, the flexible file may be used by other types of applications to store content. The flexible file 100 may contain a surface object 102. In embodiments, the surface object 102 may be used to organize and/or store content collected in the flexible file 100. As such, the surface object 102 may contain various different content items (or references to content items). The montage surface object 102 may aggregate, organize, and store the content that is included in the flexible file 100. In embodiments, the surface object 100 may be loaded by an application to display the different content. Because the montage surface object is capable of storing references to content, rather than the content itself, the size of the surface object 102 may be small in comparison to the content aggregated in the flexible file, thereby allowing a quick initial load of the flexible file by a user.

When the flexible file 100 is employed to store a montage, the surface object 102 may contain the basic properties of a single montage. The properties may include surface object grid dimensions and padding that may be used to organize the display of content in the montage, background layers that may be used to define a background for the montage (e.g., a background image or color), and theme information. The surface object may also contain a collection of tile objects (e.g., tile objects 104A, 104B, and 104C) and a collection of clip objects (e.g., clip objects 106A, 106B, and 106C). In embodiments, although clip objects 106A, 106B, and 106C may be visually associated with a tile object, such as tile object 104C, clip objects 106A, 1046B, and 106C may be stored on surface object 102. As such, if the clip objects, e.g., clip objects 106A, 106B, and 106C, are stored on surface object 102, the reordering of the clip objects clip objects 106A, 106B, and 106C in tile object 104C may comprise updating an ordered list of clip object IDs and/or teaser IDs stored in the flexible file 100. Additionally, in this embodiment a clip object may be shared between multiple tile objects (e.g., tile object 104C and tile object 104A), without exporting a large amount of data between the tile objects.

In embodiments, the surface object 102 may provide a number of adjustable properties that a user or application can set to customize the surface object 102 and/or the display of content on the surface object 102. Table 1 provides a non-limiting example of properties that may be provided by the surface object 102.

TABLE 1
Example Properties provided by a Surface object

| Property | Description |
|---|---|
| Title | A montage title. |
| Grid | The dimensions of a display grid for the surface object. |
| dimensions | The surface object may store the grid rectangle |
| | dimensions and padding. |
| tile object | Identification of tile objects that belong to the surface |
| collection | object. |
| Background | Zero or more background images that may be |
| images | displayed on the surface object. |
| Background | Zero or more gradient stops. May be used as a gradient |
| gradient stops | background of the surface object. |
| Font scheme | Font scheme details. |
| Color scheme | Color scheme details. |
| Animation | Animation scheme details (e.g., transitions used for |
| scheme | entrance, clip object transitions, enter/exit depth view). |
| tile object | Tile objects style details. Tile object styles may be |
| styles | related to a theme and may provide subtle, moderate, |
| | and intense design options for tile objects in a montage. |

In embodiments, the flexible file 100 may include a number of tile objects, such as tile objects 104A, 104B, and 104C. The tile objects may be used to associate different content into one or more groupings. For example, when a flexible file 100 is displayed, content items associated with a particular tile object may be accessed using the associated tile object. In one previously described embodiment, the clip objects and/or content may be stored in the surface object 102. In such embodiments, tile objects 104A, 104B, and 104C the clip objects and/or content may nevertheless be visually associated with the tile objects. In an alternate embodiment, the clip objects and or/content may be stored in the tile objects themselves. Although the conceptual embodiment of the flexible file 100 provided illustrates three tile objects, one of skill in the art will appreciate that more or less tile objects may be included in the surface object 102.

In embodiments, a tile object, such as tile object 104C, may be a single top-level container. Tile objects may contain one or more clip objects (e.g., clip objects 106A, 106B, and 106C) and/or content. In embodiments, a tile object may contain a template-defined placeholder clip object upon creation. For example, the flexible file may include a clip which does not yet have content associated with it, but may have content in the future. In such embodiments, the clip may be used as a placeholder. In further embodiments, a tile object may be capable of accumulating additional clip objects and/or content as the clip objects and/or content are added to the flexible file 100. Tile objects may include grid-based positioning information (e.g., column, row, column span, row span, etc.), z-order information, and shape information (e.g., rectangular, circular, elliptical, etc.). In embodiments, information may define the visual layout and/or design of the tile objects.

In embodiments, each tile object may contain more than one clip object. For example, tile object 104C contains three clip objects, clip objects 106A, 106B, and 106C. Tile objects may also provide information related to the performance of navigation between the clip objects contained within the tile object. For example, tile objects may define a manner in which the different content associated with each clip object is accessed and/or displayed. Examples of the types of navigation that may be employed with the embodiments disclosed herein include, but are not limited to, automatic navigation (e.g., timed cross-fade between clip objects in the tile object), manual navigation (e.g., next/previous buttons), or a combination of the two. In embodiments, if manual navigation is selected, a tile object may also contain information related to the storage and/or display of navigational components that a user may interact with in order to navigate between the clip objects and/or content associated with the tile object. In further embodiments, tile objects may also include information related to an animation setting (e.g., duration and delay) for automatic navigation, styling information, and title information. In embodiments, the animation settings may define an animation for automatic navigation of content or to define how content may be displayed as a preview prior to accessing the tile object. In further embodiments, a tile object may be associated with a tile object identifier that may uniquely identify the tile object. The tile object identifier information may be stored by the surface object 102 to identify the particular tile objects that reside within the surface object 102. In yet another embodiment, the tile object may be associated with or may store one or more teaser identifiers (teaser ID's). The teaser ID's may identify content that may be displayed on the surface object of a tile object before the tile object is accessed. Table 2 provides a non-limiting example of properties that may be provided by a tile object, such as tile object 104C.

TABLE 2
Example Properties provided by a tile object

| Property | Description |
|---|---|
| Shape | For example, rectangle, circle, ellipse, etc. |
| Bounds | Col/row bounds of a tile object. |
| Z-order | A z-order index for a tile object. |
| clip object type | The underlying type of clip objects and/or content |
| | associated with a tile object. |
| clip object info | Collection of information about clip objects and/or |
| collection | content associated with this tile object. |
| Navigation style | If this tile object supports a collection of content (e.g., |
| | multiple pictures), type of collection navigation for this |
| | tile object (e.g., back/next buttons on hover, navigation |
| | dots, crossfade/pan effect between sets, etc.) |
| Navigation delay | If a tile object supports a collection of content and a |
| | style that automatically transitions between them, how |
| | long to show each piece of content before transitioning |
| | to the next. |

In one embodiment, each tile object may be homogeneous meaning that each tile object is associated with only one type of content. In another embodiment, each tile object may be capable of storing heterogeneous content. In embodiments, tile objects may be associated with document content (e.g., .docx, .pptx, .pdf, .xslx, etc.), picture content (e.g., .jpg, .png, .bmp, .gif, etc.), photo albums, videos, text, feeds (e.g., RSS feeds), and/or web content. While specific examples of content associated with a tile object are provided, any type of content may be associated with a tile object.

In embodiments, the flexible file 100 may include a number of clip objects, such as clip objects 106A, 106B, and 106C. In embodiments, the clip objects may be associated with a tile object. For example, in FIG. 1, clip objects 106A, 106B, and 106C are associated with tile object 104C. Information related to content associated with the flexible file 100 may be stored in the clip objects. In one embodiment, the clip object may store an actual content item. For example, a clip object may store an image, document, video, etc. In another embodiment, the clip objects may store one or more references to a content item rather than the content itself. In such an embodiment, the actual content item is stored externally from the file. The external content may reside on a local machine, on a remote machine accessible via a network, or on the cloud. In embodiments, the cloud may be a distribution of servers storing content accessible via a network.

In embodiments where a clip object stores a reference to a content item, rather than the actual content item, the clip object may store multiple references to the content item in order to provide resiliency against the movement or reorganization of the content item. Each of the multiple references may identify the same content item; however, each reference may do so differently. For example, a clip object may store an absolute reference, a relative reference, a tokenized reference, or any other type of reference known to the art. An absolute reference may be a reference that points to the exact location of the content item. Exemplary absolute references include, but are not limited to, URL's, URI's, memory or storage addresses, etc. A relative reference may identify a content item by its relative position in a collection (e.g., package, directory, etc.). A tokenized reference is a reference capable of identifying content without relying upon name and location data. In embodiments, the one or more references stored in a clip object may identify the same content, thereby providing resiliency with respect to requesting and retrieving the content. For example, if a content item referenced in a clip object changes its location, e.g., by moving to a different storage area, an absolute reference may not correctly identify the content item but the flexible file 100 may use a relative reference or a tokenized reference to successfully request and retrieve the content item.

In embodiments, the references may refer to individual items of content or a collection of content. If high atomicity is desirable, the one or more references stored in a clip object may refer to a single content item (e.g., a single document, single image, etc.) If low atomicity is desirable, the one or more references stored in a clip object may refer to a collection of content. In low atomicity embodiments, user experience may be degraded due to the loading of a larger amount of content; however, the burden on computing resources may be eased by lowering the number of requests required to access content. As such, the clip object component of the flexible file 100 provides the ability to adjust the level of atomicity of the flexible file 100 in order to balance the needs of the user experience against the burden on local and network computer resources.

A clip object may store additional information about the content associated with the clip object. Table 2 provides a non-limiting example of properties that may be provided by a clip object, such as clip object 106A.

TABLE 3
Example Properties provided by a clip object

| Property | Description |
|---|---|
| Source info | Location of the content in this clip object. |
| Permissions info | For non-local content, BOOLEAN provided by |
| | the clip object service indicating if the content |
| | represented by this clip object is wholly public |
| | (e.g., no permission restrictions whatsoever). |
| Teaser candidate(s) | Candidates for a particular piece of content. |
| | Each content set may have 1 or more teasers. |
| Drilldown URL | Relevant information needed for drill-down on |
| | a tile object containing this clip object. |

The surface object, tile object, and clip object components provide the flexibility of the flexible file 100. In embodiments, the ability of the clip objects to store either content items or references to content may be leverage to provide flexibility. Furthermore, in embodiments, the ability of clip objects to either store content items, or one or more references to items, provides the flexible file 100 with the ability to operate in different user situations. For example, if the user is operating in an offline mode, the flexible file 100 may be adapted to store actual content items in one or more clip objects. In that manner, the flexible file 100 may be used to store and provide content in an offline environment. Alternatively, in embodiments the flexible file 100 may be successfully used in an offline mode while using references to content if the content is stored locally. Conversely, the flexible file 100 may store references to content items in clip objects and operate in an online environment. In such an embodiment, the size of the flexible file may be reduced.

In embodiment, the flexible file 100 may be an XML file. The section 102, tile objects 104A, 104B, and 104C, and clip objects 106A, 106B, and 106C may be XML elements. Alternatively, the flexible file 100 may be in a different format. For example, the flexible file may be a binary file, a HTML file, a JavaScript file, or any other type file format known to the art.

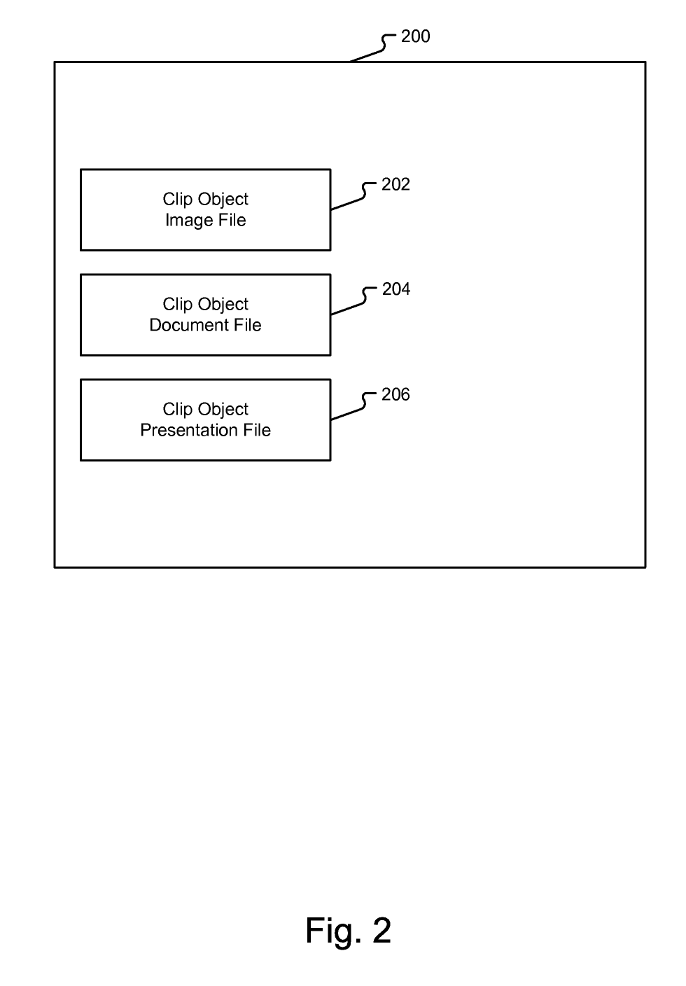

FIG. 2 is an embodiment of flexible file components that may be used to provide high atomicity in an offline mode. A tile object 200 may be associated with one or more clip objects (e.g., clip objects 202, 204, and 206). Although only three clip objects are associated with tile object 200 in FIG. 2, more or fewer clip objects may be associated with the tile object 200. In the embodiment illustrated in FIG. 2, each clip object 202, 204, and 206 may store actual content. For example, in embodiments, clip object 202 stores an image, clip object 204 stores a document, and clip object 206 stores a presentation. In the illustrated embodiment, the flexible file may be suitable to operate in an offline environment because the content items are stored within the flexible file.

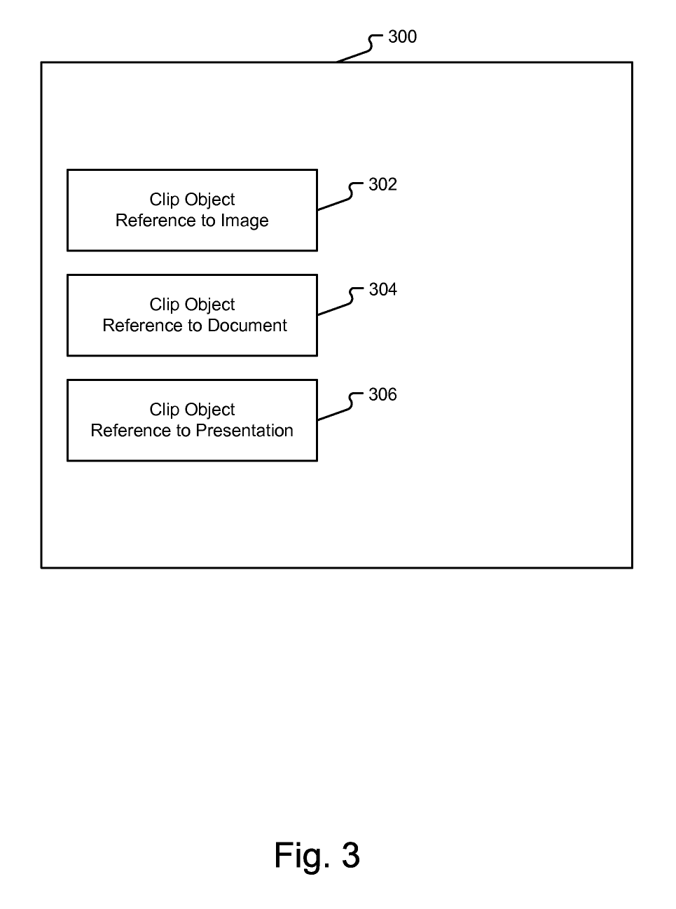

FIG. 3 is an embodiment of flexible file components that may be used to provide high atomicity in an online mode. A tile object 300 may be associated with one or more clip objects (e.g., clip objects 302, 304, and 306). Although only three clip objects are associated with tile object 300 in FIG. 3, fewer or more clip objects may be associated with the tile object 300. In the embodiment illustrated in FIG. 3, each clip object 302, 304, and 306 may store one or more references to content items. In embodiments, the references may identify a content item stored locally, but that may not be part of the flexible file format. For example, the content item may be stored on the same machine as the flexible file, but it may be stored in a different part of memory or computer storage media, in a different directory, or elsewhere on the local machine. In another embodiment, the reference may identify a content item stored remotely, for example, on a different machine accessible via a network or on the cloud.

For example, in FIG. 3 clip object 302 may contain one or more references to an image, clip object 304 may contain one or more references to a document, and clip object 306 may contain one or more references to a presentation. In embodiments, the one or more references may be an absolute reference, a relative reference, a tokenized reference, or any other type of reference known to the art. Each of the references within the clip object may identify the same content item, but in a different manner. The embodiment illustrated in FIG. 3 allows a user to individually access different content items, thereby providing the ability for the flexible file to quickly load content and enhance the user experience. However, the individual access of content may increase the number of requests and/or retrievals to access content, and may thus place an increased burden on local and network computing resources.

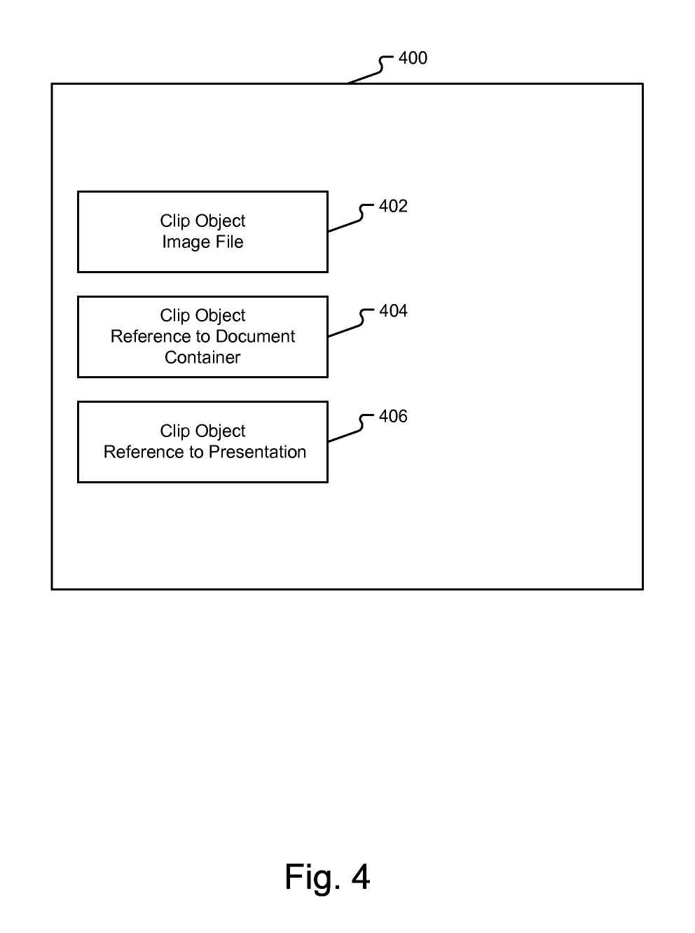

FIG. 4 is an embodiment of flexible file components that may be used to provide a balanced level of atomicity in an online mode. A tile object 400 may be associated with one or more clip objects (e.g., clip objects 402, 404, and 406). Although only three clip objects are associated with tile object 400 in FIG. 4, fewer or more clip objects may be associated with the tile object 400. In the embodiment provided in FIG. 4, clip objects 402 and 406 may store one or more references to content items. For example, clip object 402 contains one or more references to an image and clip object 406 contains one or more references to a presentation item. Clip object 404 may contain one or more references to a group of items. For example, clip object 404 contains one or more references to a container of documents which may contain a number of documents. In embodiments, referencing a container of content items may reduce the number of requests needed to retrieve content, thereby reducing the burden on local and network computing resources. In embodiments, the one or more references may be an absolute reference, a relative reference, a tokenized reference, or any other type of reference known to the art. Each of the references within the clip object may identify the same content item or same content container, but in a different manner.

Referring again to FIG. 1, the flexible file 100 may contain a number of tile objects (e.g., tile objects 104A, 104B, and 104C) and each tile object may contain a number of clip objects (e.g., clip objects 106A, 106B, and 106C). In embodiments, the clip objects may contain a content item or a reference to a content item. As such, the flexible file 100 may be capable of simultaneously incorporating different types of tile objects associated with different types of clip objects (e.g., the embodiments of FIGS. 2-4) thereby providing a high level of adaptability and flexibility to the flexible file 100. As such, the flexible file may be customized for use in many different operating scenarios.

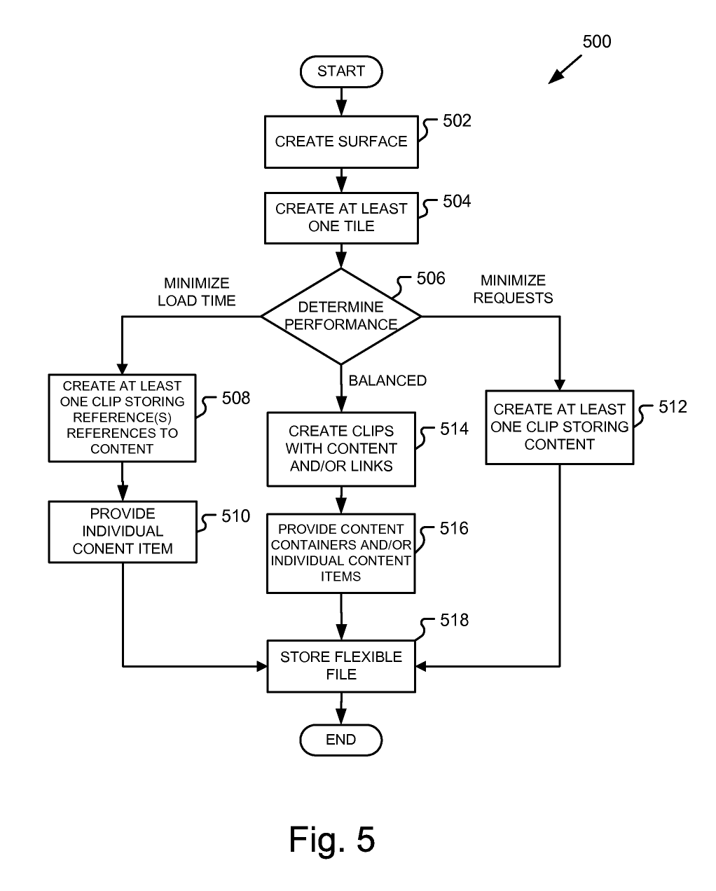

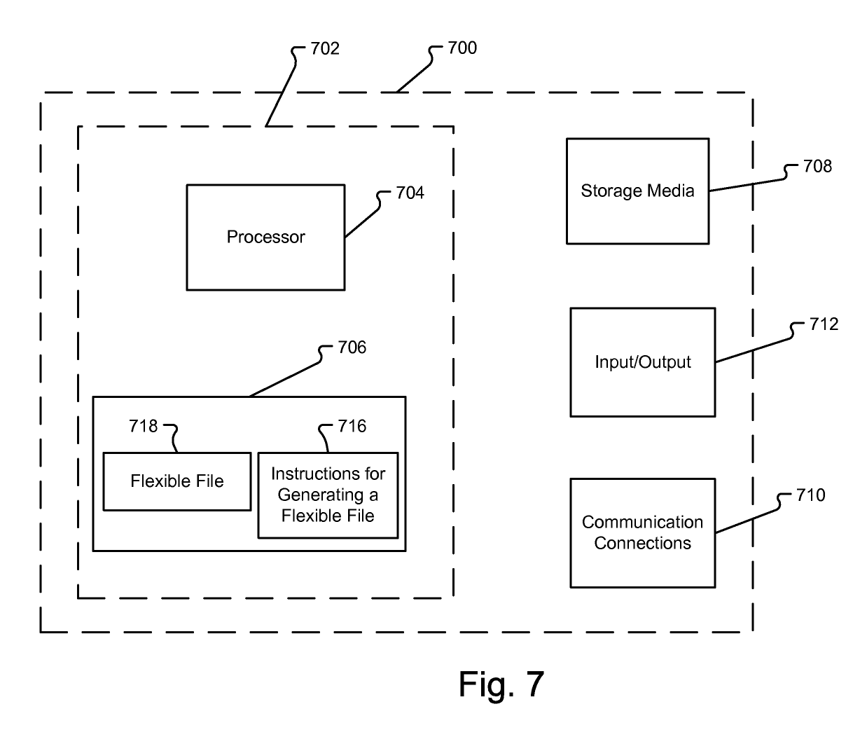

FIG. 5 is an embodiment of a method 500 that may be employed to create a flexible file. The method 500 may be performed by an application or process executing on a computing device, such as the computing system discussed with respect to FIG. 7. Flow begins at operation 502 where a surface object is created, such as surface object 102 of FIG. 1. In embodiments, the surface object created at operation 502 may be the main component of the flexible file. Flow continues to operation 504 where at least one tile object is created, such as tile objects 104A, 104B, and 104C of FIG. 1. In one embodiment, content and/or clip objects included in the flexible file may be associated with a tile object. In another embodiment, the tile object may act as a container for storing any content and/or clip objects included in the flexible file.

Flow continues to decision operation 506. At decision operation 506 the method of creating the flexible file makes a determination or receives an indication of the type of user scenario and/or situation the flexible file may be optimized for. For example, the flexible file may be optimized for best user experience (e.g., fast load time), the flexible file may be optimized to manage local and/or network computing resources (e.g., minimize requests for content), or the flexible file make take a balanced approach. In embodiments, the indication provides instruction as to how the flexible file should be optimized. For example, the indication may include instructions for saving storing some data within the flexible file while storing references to other data within the file. In embodiments, the instructions as to whether to store the content within the flexible file may be the type of content, size of content, or other characteristics of the content. Although the method 500 is illustrated as providing three different types of optimization, one of skill in the art will appreciate that the flexible file may be created so as to fall anywhere on a spectrum between storing all the content within the file itself or storing all the content remotely by including a mixture of stored content, individually referenced content, and/or collectively referenced content.

In one embodiment, the determination made at operation 506 may be based upon an indication received by the application and/or process performing the method 500. For example, an indication of a preference set by the user may be used to make the determination at operation 506. In another embodiment, the determination may be made dynamically based upon usage history, network resources, the amount of content included in the flexible file, or by any other mechanism.

In embodiments, if the flexible file is to be optimized for minimal load time (e.g., maximize user experience) flow branches “MINIMIZE LOAD TIME” from decision 506 to operation 508. At operation 508, one or more clip objects are created that store one or more references to one or more content items, rather than storing the actual content items. In embodiments, the one or more references may be absolute references, relative references, tokenized references, or any other type of reference known to the art. Flow continues to operation 510 where the one or more reference content items are stored external to the flexible file, either on a local machine, a remote machine, distributed across a network of machines (e.g., stored on a cloud), or in a combination of locations. In order to increase load times, the one or more content items stored at operation 510 may be stored individually thereby allowing the request and retrieval of individual pieces of content thus minimizing load time. In a particular embodiment, for example, operations 508 and 510 may create a flexible file that may contain a majority of components similar to the embodiment illustrated in FIG. 3 in order to minimize load time; however, other types of components may also be included in the flexible file. Once all the clip objects are created in operation 508 and all the content stored in operation 510 flow continues to operation 518 where the flexible file is stored, by, for example, writing the flexible file to memory.

In embodiments, if the flexible file is to be optimized to minimize the burden on local and/or network computing resources, flow branches “MINIMIZE REQUESTS” from decision 506 to operation 512. At operation 512 one or more clip objects that store one or more content items. In a particular embodiment, for example, operation 512 may create a flexible file that may contain a majority of component similar to the embodiment illustrated in FIG. 2 in order to minimize requests and retrieval of content; however, other types of components may also be included in the flexible file. In embodiments, the content stored in the clip objects at operation 512 may be stored individually or as a collection. Once all the clip objects are created in operation 512 flow continues to operation 518 where the flexible file is stored, by, for example, writing the flexible file to memory.

In embodiments, a more balanced flexible file may be created in which case flow branches “BALANCED” from decision 506 to operation 514. At operation 512 a plurality of clip objects may be created. The plurality of clip objects may include clip objects that store content items, store references to individual content items, and/or store references to collections of content. Furthermore, clip objects storing references may store absolute references, relative references, tokenized references, or any other type of reference known to the art. Flow continues to operation 516 where content not stored in the clip objects at operation 514 may be stored individually, as a collection of content, or both. The individual and collective content may be stored external to the flexible file either on a local machine, a remote machine, distributed across a network of machines (e.g., stored on a cloud), or in a combination of locations. In a particular embodiment, for example, 514 and 516 may create a flexible file that may contain a majority of components similar to the embodiment illustrated in FIG. 4. Once all the clip objects are created in operation 514 and all the content stored in operation 516 flow continues to operation 518 where the flexible file is stored, by, for example, writing the flexible file to memory.

In embodiments, once the flexible file is created the file may be modified to adapt to changing user scenarios and/or hardware conditions. For example, a clip that stores a content item in the flexible file may be modified at a later time to store references to the content item. The content item previously stored in the clip may be moved such that it is stored external from the file, either locally or remotely. The moved content item may be externally stored individually or as part of a collection of content. Similarly, a clip that stored one or more references to a content item or collection of content may be modified to store the actual content item or collection of content item. As such, the structure of the flexible file provides fluidity to the file that allows the file to adapt to changing conditions.

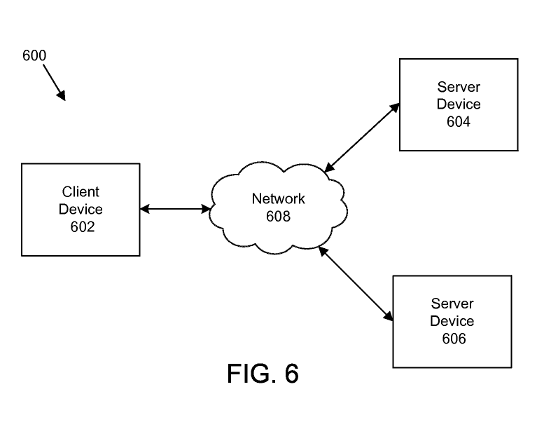

FIG. 6 is an embodiment of a network system 600 that may be employed with the various embodiments described herein. The network system 600 may include a client device 602. In embodiments, a client device may be a personal computer, a laptop computer, a tablet computer, a smartphone, or any other type of computing device. The client device may be in electrical communication with one or more remote devices, such a server device 604 and server device 606 via a network, such as network 608. In embodiments, server devices 604 and 606 may be a server computer or any other type of computing device. In one embodiment, server devices 604 and 606 may be part of a server cluster or may be part of a cloud network. In another embodiment, server devices 604 and 606 may be separate, unrelated devices. Network 608 may be a LAN, a WAN, a cellular network, the Internet, or any other type of network capable of facilitating communications between computing devices.

A user may open a flexible file on the client device 602 to access content aggregated by the flexible file. In one embodiment, the content aggregated in the flexible file may reside on the client device 602. For example, the aggregated content may reside in the flexible file itself or on the client computer 602. In another embodiment, the flexible file accessed on the client device 602 may contain one or more references to content that resides remotely, for example, on server devices 604 and 606. If the content resides remotely, the client device may issue one or more requests for the content to server devices 604 and 608 via network 608. Server devices 604 and 608 may return content to the client device via network 608.

With reference to FIG. 7, an embodiment of a computing environment for implementing the various embodiments described herein includes a computer system, such as computer system 700. Any and all components of the described embodiments may execute as or on a client computer system, a server computer system, a combination of client and server computer systems, a handheld device, and other possible computing environments or systems described herein. As such, a basic computer system applicable to all these environments is described hereinafter.

In its most basic configuration, computer system 700 comprises at least one processing unit or processor 704 and system memory 707. The most basic configuration of the computer system 700 is illustrated in FIG. 7 by dashed line 702. In some embodiments, one or more components of the described system are loaded into system memory 707 and executed by the processing unit 704 from system memory 706. Depending on the exact configuration and type of computer system 700, system memory 706 may be volatile object (such as RAM), non-volatile object (such as ROM, flash memory, etc.), or some combination of the two.

Additionally, computer system 700 may also have additional features/functionality. For example, computer system 700 includes additional storage media 708, such as removable and/or non-removable storage, including, but not limited to, magnetic or optical disks or tape. In some embodiments, software or executable code and any data used for the described system is permanently stored in storage media 708. Storage media 708 includes volatile object and non-volatile object, removable and non-removable media implemented in any method or technology for storage of information such as computer readable instructions, data structures, program modules, or other data. In embodiments, the disclosed flexible files and the instructions to perform the methods of creating flexible files 708.

System memory 706 and storage media 708 are examples of computer storage media. Computer storage media includes, but is not limited to, RAM, ROM, EEPROM, flash memory or other memory technology, CD-ROM, digital versatile object disks (“DVD”) or other optical storage, magnetic cassettes, magnetic tape, magnetic disk storage, other magnetic storage devices, or any other medium which is used to store the desired information and which is accessed by computer system 700 and processor 704. Any such computer storage media may be part of computer system 700. In embodiments, system memory 706 and/or storage media 708 stores data used to perform the methods and/or form the system(s) disclosed herein, such as, the embodiments of flexible files and the methods to create the flexible files disclosed herein. In embodiments, system memory 706 stores information such as a flexible file 718 and instructions for generating a flexible file 716.

Computer system 700 may also contain communications connection(s) 710 that allow the device to communicate with other devices. In embodiments, communications connection(s) 710 may be used to transmit and receive messages between sender devices, intermediary devices, and recipient devices. Communication connection(s) 710 is an example of communication media. Communication media may embody a modulated data signal, such as a carrier wave or other transport mechanism and includes any information delivery media, which may embody computer readable instructions, data structures, program modules, or other data in a modulated data signal. The term “modulated data signal” means a signal that has one or more of its characteristics set or changed in such a manner as to encode information or a message in the data signal. By way of example, and not limitation, communication media includes wired media such as a wired network or direct-wired connection, and wireless media such as an acoustic, RF, infrared, and other wireless media.

In some embodiments, computer system 700 also includes input and output connections 712, and interfaces and peripheral devices, such as a graphical user interface. Input device(s) are also referred to as user interface selection devices and include, but are not limited to, a keyboard, a mouse, a pen, a voice input device, a touch input device, etc. Consistent with embodiments of the present disclosure, the input device may comprise any motion detection device capable of detecting the movement of a user. For example, the input device may comprise a KINECT® motion capture device, from Microsoft Corporation, comprising a plurality of cameras and a plurality of microphones. Other embodiments are possible. Output device(s) are also referred to as displays and include, but are not limited to, cathode ray tube displays, plasma screen displays, liquid crystal screen displays, speakers, printers, etc. These devices, either individually or in combination, connected to input and output connections 712 are used to display the information as described herein. All these devices are well known in the art and need not be discussed at length here.

In some embodiments, the component described herein comprise such modules or instructions executable by computer system 700 that may be stored on computer storage medium and other tangible mediums and transmitted in communication media. Computer storage media includes volatile object and non-volatile object, removable and non-removable media implemented in any method or technology for storage of information such as computer readable instructions, data structures, program modules, or other data. Combinations of any of the above should also be included within the scope of readable media. In some embodiments, computer system 700 is part of a network that stores data in remote storage media for use by the computer system 700.

The example embodiments described herein can be implemented as logical operations in a computing device in a networked computing system environment. The logical operations can be implemented as: (i) a sequence of computer implemented instructions, steps, or program modules running on a computing device; and (ii) interconnected logic or hardware modules running within a computing device.

For example, embodiments of the present disclosure may be practiced via a system-on-a-chip (SOC) where each or many of the components illustrated in FIG. 7 may be integrated onto a single integrated circuit. Such an SOC device may include one or more processing units, graphics units, communication units, system virtualization units and application functionality, all of which are integrated onto a chip substrate as a single integrated circuit.

Additionally, the logical operations can be implemented as algorithms in software, firmware, analog/digital circuitry, and/or any combination thereof, without deviating from the scope of the present disclosure. The software, firmware, or similar sequence of computer instructions can be encoded and stored upon a computer readable storage medium and can also be encoded within a carrier-wave signal for transmission between computing devices.

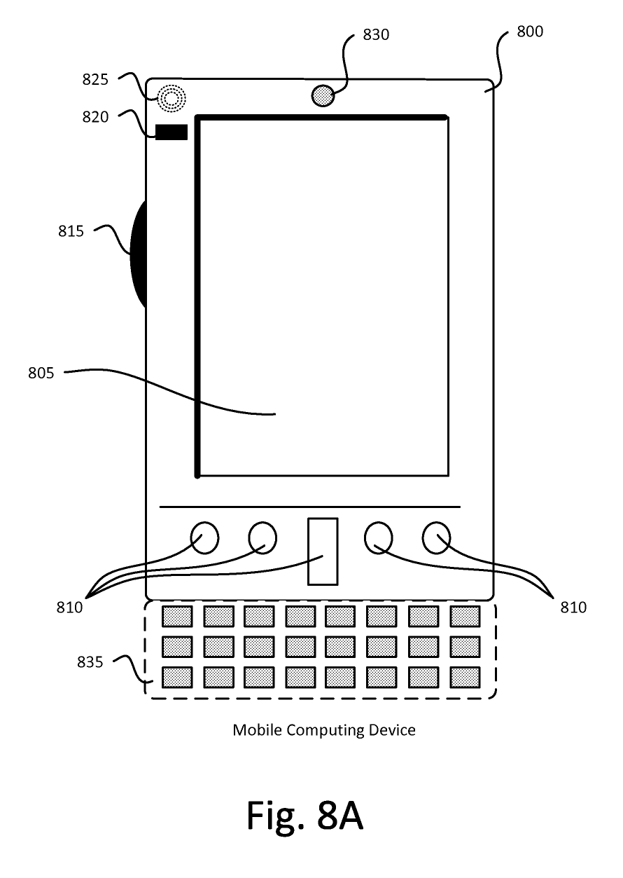

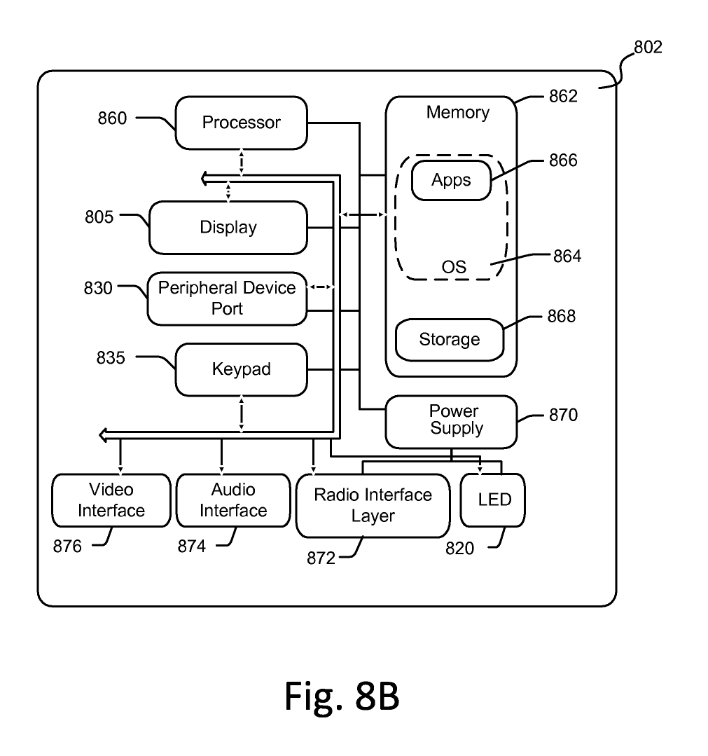

FIGS. 8A and 8B illustrate a mobile computing device 800, for example, a mobile telephone, a smart phone, a tablet personal computer, a laptop computer, and the like, with which embodiments of the disclosure may be practiced. With reference to FIG. 8A, an exemplary mobile computing device 800 for implementing the embodiments is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative embodiments, mobile computing device 800 may incorporate more or less input elements. For example, the display 805 may not be a touch screen in some embodiments. In yet another alternative embodiment, the mobile computing device 800 is a portable phone system, such as a cellular phone. The mobile computing device 800 may also include an optional keypad 835. Optional keypad 835 may be a physical keypad or a “soft” keypad generated on the touch screen display. In various embodiments, the output elements include the display 805 for showing a graphical user interface (GUI), a visual indicator 820 (e.g., a light emitting diode), and/or an audio transducer 825 (e.g., a speaker). In some embodiments, the mobile computing device 800 incorporates a vibration transducer for providing the user with tactile feedback. In yet another embodiment, the mobile computing device 800 incorporates input and/or output ports, such as an audio input (e.g., a microphone jack), an audio output (e.g., a headphone jack), and a video output (e.g., a HDMI port) for sending signals to or receiving signals from an external device. In embodiments, the content stored in the flexible file format may be displayed on the display 805.

Although described herein in combination with the mobile computing device 800, in alternative embodiments of the disclosure may be used in combination with any number of computer systems, such as in desktop environments, laptop or notebook computer systems, multiprocessor systems, micro-processor based or programmable consumer electronics, network PCs, mini computers, main frame computers and the like. Embodiments of the disclosure may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present invention.

FIG. 8B is a block diagram illustrating the architecture of one embodiment of a mobile computing device. That is, the mobile computing device 800 can incorporate a system (i.e., an architecture) 802 to implement some embodiments. In one embodiment, the system 802 is implemented as a “smart phone” capable of running one or more applications (e.g., browser, e-mail, calendaring, contact managers, messaging clients, games, and media clients/players). In some embodiments, the system 802 is integrated as a computing device, such as an integrated personal digital assistant (PDA) and wireless phone.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, diagramming applications, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800, including the flexible file format, the method of creating a flexible file, and the method of preserving unknown file contents disclosed herein.

The system 802 has a power supply 870, which may be implemented as one or more batteries. The power supply 870 might further include an external power source, such as an AC adapter or a powered docking cradle that supplements or recharges the batteries.

The system 802 may also include a radio 872 that performs the function of transmitting and receiving radio frequency communications. The radio 872 facilitates wireless connectivity between the system 802 and the “outside world”, via a communications carrier or service provider. Transmissions to and from the radio 872 are conducted under control of the operating system 864. In other words, communications received by the radio 872 may be disseminated to the application programs 866 via the operating system 864, and vice versa. The radio 872 allows the system 802 to communicate with other computing devices, such as over a network. The radio 872 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of the system 802 provides notifications using the visual indicator 820 that can be used to provide visual notifications and/or an audio interface 874 producing audible notifications via the audio transducer 825. In the illustrated embodiment, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with embodiments of the present invention, the microphone may also serve as an audio sensor to facilitate control of notifications, as will be described below. The system 802 may further include a video interface 876 that enables an operation of an on-board camera 830 to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8B by the non-volatile storage area 868. Computer storage media may include volatile and nonvolatile, removable and non-removable media implemented in any method or technology for storage of information, such as computer readable instructions, data structures, program modules, or other data.

Data/information generated or captured by the mobile computing device 800 and stored via the system 802 may be stored locally on the mobile computing device 800, as described above, or the data may be stored on any number of storage media that may be accessed by the device via the radio 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio 872 or via a distributed computing network. Similarly, such data/information may be readily transferred between computing devices for storage and use according to well-known data/information transfer and storage means, including electronic mail and collaborative data/information sharing systems.

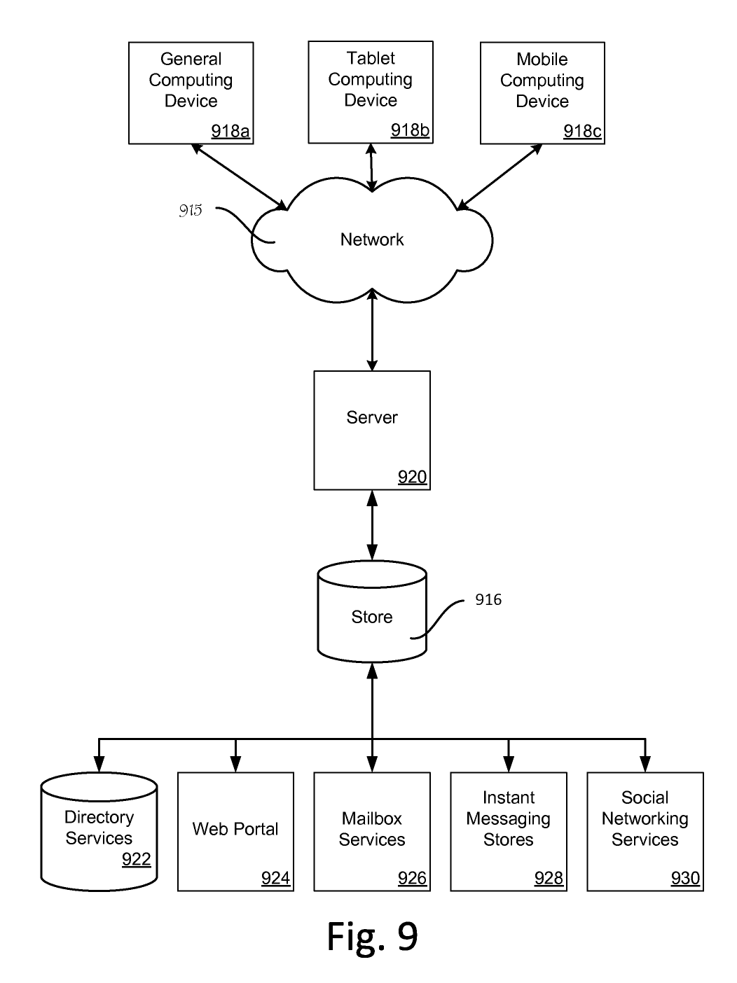

FIG. 9 illustrates one embodiment of the architecture of a system for providing the flexible file 100 and the methods disclosed herein to one or more client devices, as described above. Content developed, interacted with or edited in association with the flexible file 102 may be stored in different communication channels or other storage types. For example, various documents may be stored using a directory service 922, a web portal 924, a mailbox service 926, an instant messaging store 928, or a social networking site 930. The flexible file 102 may use any of these types of systems or the like for enabling data utilization, as described herein. A server 920 may provide the flexible file 102 and/or methods for creating or modifying flexible files disclosed herein to clients. As one example, the server 920 may be a web server providing the flexible file 102 and/or the methods for creating or modifying the flexible file disclosed herein over the web. The server 920 may provide the flexible file 102 and/or methods for creating or modifying the flexible file disclosed herein over the web to clients through a network 915. By way of example, the client computing device 918 may be implemented as the computing device 700 and embodied in a personal computer 918a, a tablet computing device 918b and/or a mobile computing device 918c (e.g., a smart phone). Any of these embodiments of the client computing device 918 may obtain content from the store 916. In various embodiments, the types of networks used for communication between the computing devices that make up the present invention include, but are not limited to, an internet, an intranet, wide area networks (WAN), local area networks (LAN), and virtual private networks (VPN). In the present application, the networks include the enterprise network and the network through which the client computing device accesses the enterprise network (i.e., the client network). In one embodiment, the client network is part of the enterprise network. In another embodiment, the client network is a separate network accessing the enterprise network through externally available entry points, such as a gateway, a remote access protocol, or a public or private internet address.

This disclosure described some embodiments with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although the embodiments have been described in language specific to structural features, methodological acts, and computer-readable media containing such acts, it is to be understood that the possible embodiments, as defined in the appended claims, are not necessarily limited to the specific structure, acts, or media described. One skilled in the art will recognize other embodiments or improvements that are within the scope and spirit of the present disclosure. Therefore, the specific structure, acts, or media are disclosed only as illustrative embodiments. The disclosure is defined by the appended claims.

What is claimed is:

1. A method for creating a flexible file, the method comprising:
creating a surface object as a part of the flexible file;
creating a first tile object, wherein the first tile object resides within the surface object;
receiving an indication to optimize loading of the flexible file;
in response to receiving the indication, creating a first clip object associated with the first tile object, wherein the first clip object comprises a first plurality of references to a first content item; and
storing the flexible file.

2. The method of claim 1, wherein the first plurality of references comprises;
an absolute URL;
a relative link; and
wherein the absolute URL and the relative link identify the first data item.

3. The method of claim 2, wherein the first plurality of references further comprise a tokenized URL, wherein the tokenized URL identifies the first data item.

4. The method of claim 1, wherein the surface object references a background image.

5. The method of claim 1, wherein the first tile object is positioned on a display grid associated with the surface object.

6. The method of claim 1, wherein the first tile object comprises information identifying the type of the first content item.

7. The method of claim 1, further comprising:
creating a second clip object that is associated with the first tile object, wherein the second clip object comprises a second plurality of references to a second content item.

8. The method of claim 7, wherein the first tile object comprises information identifying a navigation style for navigating, on a display, from the first clip object to the second clip object.

9. The method of claim 1, wherein the first content item resides on a network.

10. The method of claim 9, wherein the first clip object further comprises permission information for the first content item.

11. The method of claim 1, further comprising:
creating a second tile object, wherein the second tile object container resides in the surface object; and
creating a second clip object that is associated with the second tile object, wherein the second clip object comprises a second plurality of references to a collection of content.

12. A method for creating a montage file, the method comprising:
creating a surface object as a part of the montage file;
creating a first tile object, wherein the first tile object resides in the surface object;
receiving an indication to minimize requests for content;
in response to receiving the indication, creating a first clip object associated with the first tile object, wherein the first clip object comprises a first content item; and
storing the montage file.

13. The method of claim 12, further comprising, creating a second clip object associated with the first tile object, wherein the second clip object comprises a second data item.

14. The method of claim 12, further comprising creating a second clip object associated with the first tile object, wherein the second clip object comprises a second content item.

15. The method of claim 14, wherein the first tile object and the second tile object are positioned on a grid associated with the surface object.

16. The method of claim 12, further comprising
creating a second tile object, wherein the second tile object resides in the surface object; and
creating a second clip object, wherein the second clip object comprises a plurality of references to a collection of content.

17. The method of claim 11, wherein the first content item comprises one of:
a document;
a picture; and
a video.

18. A computer storage medium encoding computer executable instructions that, when executed by at least one processor, perform a method for creating a montage file, the method comprising:
creating a surface object as a part of the montage file;
creating a first tile object, wherein the first tile object resides in the surface object;
creating a first clip object associated with the first tile object, wherein the first clip object comprises a first plurality of references to a first content item;
creating a second clip object associated with the first tile object, wherein the second clip object comprises a second content item;
creating a second tile object, wherein the second tile object resides in the surface object;
creating a third clip object associated with the second tile object, wherein the third clip object comprises a second plurality of references to a collection of content; and
storing the montage file.

19. The computer storage medium of claim 18, wherein the first plurality of references comprises:
an absolute reference;
a relative link;
a tokenized link; and
wherein the absolute reference, the relative link, and the tokenized link identify the first data item.

20. The computer storage medium of claim 18, wherein the first content item and the collection of content are stored on a network.
